(19) United States
(12) Patent Application Publication
(10) Pub. No.: US 2013/0034150 A1
(43) Pub. Date: Feb. 7, 2013

(54) SYSTEMS AND METHODS FOR MULTIMEDIA DATA ENCODING AND DECODING

(71) Applicant: Mangesh Devidas Sadafale, Maharashtra (IN)

(72) Inventor: Mangesh Devidas Sadafale, Maharashtra (IN)

(73) Assignee: TEXAS INSTRUMENTS INCORPORATED, Dallas, TX (US)

(21) Appl. No.: 13/406,172

(22) Filed: Feb. 27, 2012

(30) Foreign Application Priority Data
Aug. 5, 2011 (IN) 2695/CHE/2011

(51) Int. Cl. H04N 7/30

(52) U.S. Cl. 375/240.03; 375/240.18; 375/240.2; 375/240.12; 375/240.25; 375/E07.027; 375/E07.142; 375/E07.214

(57) ABSTRACT

Several methods and systems for encoding and decoding multimedia data are disclosed. In an embodiment, a system for decoding multimedia data includes a decoding module and an inverse transformation module. The inverse transformation module includes a first inverse transform module, a transpose buffer and a second inverse transform module. The decoding module decompresses encoded multimedia data using a pre-configurable scan order to provide a decompressed matrix of transform coefficients. The first inverse transform module inversely transforms the decompressed matrix of transform coefficients to provide an intermediate output matrix of transform coefficients, the transpose buffer transposes the intermediate output matrix to provide a transposed intermediate output matrix of transform coefficients, and the second inverse transform module inversely transforms the transposed intermediate output matrix of transform coefficients to provide inversely transformed multimedia data.

### CROSS REFERENCE TO RELATED APPLICATIONS

This application claims the benefit of Indian Provisional Patent Application No. 2695/CHE/2011, filed in the Indian Patent Office on Aug. 5, 2011, which is incorporated herein by reference in its entirety.

### TECHNICAL FIELD

The present disclosure generally relates to the field of multimedia data encoding and decoding.

### BACKGROUND

Pursuant to an exemplary scenario, multimedia systems implement efficient methods of encoding and decoding multimedia data for storage and transmission purposes. Examples of multimedia systems may include, but are not limited to, (1) multimedia devices, such as cellular phones, digital video cameras and digital camcorders; (2) data processing devices, such as personal computers, laptops and personal digital assistants; and (3) consumer electronics, such as set top boxes, digital video disk (DVD) players and video network servers. Examples of multimedia data may include, for example, video data, image data, audio-video data, graphical data, textual data or any combination thereof.

Pursuant to one exemplary scenario, a multimedia system may include a number of components, one or more of which may facilitate the implementation of encoding and decoding multimedia data. The processing of multimedia data by a number of components for encoding/decoding purposes may induce or cause a delay in overall processing, thereby affecting a performance of the multimedia system.

### SUMMARY

Various methods and systems for encoding and decoding multimedia data encoding are disclosed. In an embodiment, a system for decoding multimedia data is disclosed. In an embodiment, the system includes a decoding module and an inverse transformation module. The decoding module is configured to decompress encoded multimedia data using a pre-configurable scan order to provide a decompressed matrix of transform coefficients. The inverse transformation module comprises a first inverse transform module, a transpose buffer and a second inverse transform module. The first inverse transform module is communicatively associated with the decoding module and is configured to inversely transform the decompressed matrix of transform coefficients to provide an intermediate output matrix of transform coefficients, the transpose buffer is communicatively associated with the first inverse transform module and is configured to transpose the intermediate output matrix of transform coefficients to provide a transposed intermediate output matrix of transform coefficients, and the second inverse transform module is communicatively associated with the transpose buffer and is configured to inversely transform the transposed intermediate output matrix of transform coefficients to provide inversely transformed multimedia data.

In an embodiment, the pre-configurable scan order of the decoding module is pre-configured to be a reverse scanning order. In an embodiment, each of the first inverse transform module and the second inverse transform module is configured to perform at least one of a one-dimensional (1-D) Inverse Discrete Cosine Transform (IDCT), a 1-D Inverse Discrete Sine Transform (IDST), a 1-D Inverse Karhunen-Loève Transform (IKLT) transform and a 1-D Hadamard transform. In an embodiment, the system is a high efficiency video coding (HEVC) based decoder. In an embodiment, the system is one of a moving picture experts group (MPEG)-1 based decoder, MPEG-2 based decoder and MPEG-4 based decoder. In an embodiment, the system includes a de-quantization module communicatively associated with the decoding module and the inverse transformation module and configured to de-quantize the decompressed matrix of transform coefficients prior to an inverse transformation of the decompressed matrix of transform coefficients into the intermediate output matrix of transform coefficients.

In one embodiment, a system for encoding multimedia data is disclosed. The system includes a forward transformation module and an encoding module. The forward transformation module includes a first forward transform module, a first transpose buffer and a second forward transform module. The first forward transform module transforms multimedia data to provide an intermediate input matrix of transform coefficients, the first transpose buffer is communicatively associated with the first forward transform module and is configured to transpose the intermediate input matrix to provide a transposed intermediate input matrix of transform coefficients, and the second forward transform module is communicatively associated with the first transpose buffer and is configured to transform the transposed intermediate matrix of transform coefficients to provide transformed multimedia data. In an embodiment, each of the first forward transform module and the second forward transform module is configured to perform at least one of a 1-D Discrete Cosine Transform (DCT), a 1-D Discrete Sine Transform (DST), a 1-D Karhunen-Loève Transform (KLT) and a 1-D Hadamard transform. The encoding module is configured to compress the transformed multimedia data using a pre-configurable scan order to provide a compressed matrix of transform coefficients.

In an embodiment, the system includes a quantization module communicatively associated with the forward transformation module and with the encoding module and which is configured to quantize the transformed multimedia data prior to a compression of the transformed multimedia data. In an embodiment, the system includes a de-quantization module and an inverse transformation module. The de-quantization module is communicatively associated with the quantization module and is configured to de-quantize a quantization of the transformed multimedia data to provide de-quantized multimedia data. The inverse transformation module comprises a first inverse transform module, a second transpose buffer and a second inverse transform module. The first inverse transform module is communicatively associated with the de-quantization module and is configured to inversely transform the de-quantized multimedia data to provide an intermediate output matrix of transform coefficients, the second transpose buffer is communicatively associated with the first inverse transform module and is configured to transpose the intermediate output matrix to provide a transposed intermediate output matrix of transform coefficients and the second inverse transform module is communicatively associated with the second transpose buffer and is configured to inversely transform the transposed intermediate output matrix of transform coefficients to provide inversely transformed multimedia data.

Additionally, in an embodiment, a computer implemented method for decoding multimedia data is disclosed. The method includes performing decompression of encoded multimedia data using a pre-configurable scan order to provide a decompressed matrix of transform coefficients, and inversely transforming the decompressed matrix of transform coefficients to provide an intermediate output matrix of transform coefficients. The method further includes transposing the intermediate output matrix of transform coefficients to provide a transposed intermediate output matrix of transform coefficients, and inversely transforming the transposed intermediate output matrix of transform coefficients to provide inversely transformed multimedia data.

In one embodiment, a computer implemented method for encoding multimedia data is disclosed. The method includes transforming multimedia data to provide an intermediate input matrix of transform coefficients, and transposing the intermediate input matrix of transform coefficients to provide a transposed intermediate input matrix of transform coefficients. The method further includes transforming the transposed intermediate matrix of transform coefficients to provide transformed multimedia data, and performing compression of the transformed multimedia data using a pre-configurable scan order to provide a compressed matrix of transform coefficients.

Moreover, in an embodiment, an integrated circuit for decoding and encoding multimedia data is disclosed. The integrated circuit comprises a transceiver module, a multimedia processing module and a memory module. The transceiver module is communicatively associated with a plurality of multimedia resources and is configured to receive multimedia data from at least one multimedia resource from among the plurality of multimedia resources. The multimedia-processing module is communicatively associated with the transceiver module and is configured to perform at least one of encoding of multimedia data and decoding of encoded multimedia data. The memory module is communicatively associated with the transceiver module and the multimedia processing module and is configured to store the multimedia data subsequent to one of encoding of multimedia data and decoding of multimedia data.

### BRIEF DESCRIPTION OF THE FIGURES

FIGS. 1A and 1B illustrate simplified overviews of encoding and decoding multimedia data, respectively, in accordance with an exemplary scenario;

FIGS. 2A and 2B illustrate block diagrams of exemplary process flow implementations for decoding and encoding multimedia data, respectively, in accordance with an exemplary scenario;

FIG. 3 illustrates variations in process flow implementations for decoding multimedia data according to an embodiment;

FIG. 4 is a block diagram of a system for decoding multimedia data according to an embodiment;

FIG. 5 illustrates variations in process flow implementations for encoding multimedia data according to an embodiment;

FIG. 6 is a block diagram of a system for encoding multimedia data according to an embodiment;

FIG. 7 is a flow diagram of a method for decoding multimedia data according to an embodiment;

FIG. 8 is a flow diagram of a method for encoding multimedia data according to an embodiment; and

FIG. 9 is a block diagram of an integrated circuit for decoding and encoding multimedia data according to an embodiment.

### DETAILED DESCRIPTION

Pursuant to an exemplary scenario, multimedia systems include a number of components for facilitating the encoding and decoding of multimedia data. The processing of multimedia data by a number of components for encoding/decoding purposes induces or causes a delay in overall processing, thereby affecting a performance of such multimedia systems. Various embodiments of the present technology, however, provide systems and methods for encoding and decoding multimedia data that are capable of overcoming these and other obstacles and providing additional benefits.

The following description and accompanying figures demonstrate that the present technology may be practiced or otherwise implemented in a variety of different embodiments. It should be noted, however, that the scope of the present technology is not limited to any or all of the embodiments disclosed herein. Indeed, one or more of the devices, features, operations, processes, characteristics, or other qualities of a disclosed embodiment may be removed, replaced, supplemented, or changed.

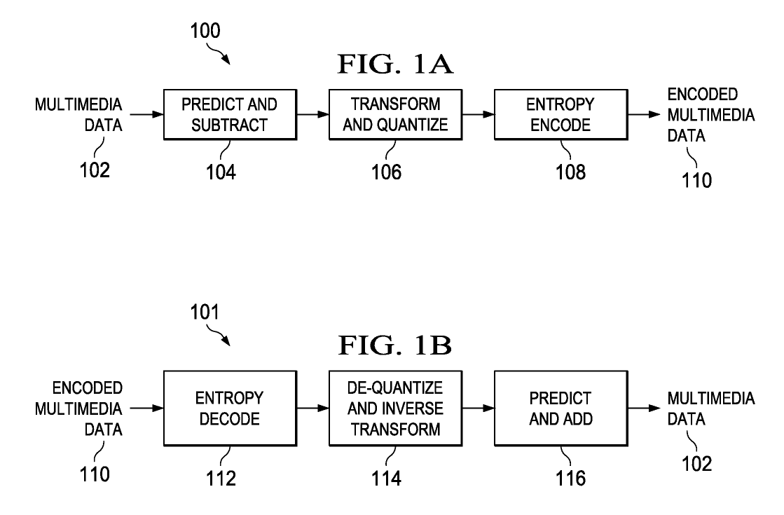

FIGS. 1A and 1B illustrate simplified overviews of encoding and decoding multimedia data 102, respectively, in accordance with an exemplary scenario. In particular, FIG. 1A illustrates a simplified overview of an encoding process flow 100 for encoding multimedia data 102. Pursuant to an exemplary scenario, a multimedia encoder may perform the encoding process flow 100 to achieve the compression of the multimedia data 102. The multimedia data 102 may be compressed so as to efficiently utilize a storage capacity during storage or a spectrum/bandwidth during transmission.

The multimedia encoder may be configured within a multimedia system. Examples of the multimedia system may include, but are not limited to, (1) multimedia devices, such as cellular phones, digital video cameras and digital camcorders; (2) data processing devices, such as personal computers, laptops and personal digital assistants; and (3) consumer electronics, such as set top boxes, digital video disk (DVD) players and video network servers. Pursuant to an exemplary scenario, the multimedia encoder may be any machine capable of executing a set of instructions (sequential and/or otherwise) so as to perform an encoding of multimedia data.

The multimedia data 102 may be received by the multimedia encoder from a media capture device. Examples of a media capture device may include a video camera or a camcorder. The media capture device may be, for example, a stand-alone device or a part of a mobile device, such as a Smartphone, or a data processing device, such as a personal computer, a laptop device or a personal digital assistant (PDA). The multimedia data 102 may also be received by the multimedia encoder from a transcoding system (implemented in any of hardware, software or firmware), which may be stand-alone device or a part of media capture device. Examples of multimedia data 102 may include, for example, video data, image data, audio-video data, graphical data, textual data or any combination thereof.

Pursuant to an exemplary scenario, the multimedia data 102 may include a plurality of frames, and each frame of the plurality of frames may include several blocks of data. At 104 of the encoding process flow 100, a prediction for each block from among a number of blocks of multimedia data 102 is determined and subtracted from the block to form a residual multimedia data. The prediction for each block of multimedia data 102 may be performed based on previously encoded blocks of multimedia data 102, either from current frame (e.g., intra prediction) or from other frames that have already been encoded and transmitted (e.g., inter prediction). Identifying a suitable inter-prediction may be referred to as motion estimation and subtracting the inter-prediction from the current block may be referred to as motion compensation.

After prediction and subtraction, at 106, the residual multimedia data is transformed and quantized. The transformation of the residual multimedia data outputs a set of transform coefficients, each of which is a weighting value for a standard basis pattern. The weighted basis patterns, when combined, are capable of re-creating the residual multimedia data. The set of transform coefficients are then quantized (such as where each coefficient is scaled corresponding to a scale-down factor which may be a mathematical reciprocal of the scale-up factor specified by a multimedia standard, effectively setting a number of transform coefficients to a small value (including zero value)) to achieve compression.

The quantized transform coefficients, along with certain information (for example, information such as: information about the structure of compressed data, information about a complete sequence of multimedia data 102 and/or information that enables a decoder to re-create the prediction), are subject to entropy encoding (e.g., conversion into binary codes using variable length coding and/or arithmetic coding) at 108. The entropy encoding of the multimedia data 102 produces an efficient, compact binary representation of the information in the form of encoded multimedia data 110. The encoded multimedia data 110 may then be stored and/or transmitted.

FIG. 1B illustrates a simplified overview of a decoding process flow 101 for decoding encoded multimedia data 110. Pursuant to an exemplary scenario, a multimedia decoder may perform the decoding process flow 101 to achieve the decompression of the multimedia data 102. The multimedia decoder may be configured within a multimedia system, such as the multimedia system of FIG. 1A. At 112, the encoded multimedia data 110 may be entropy decoded (e.g., converted from the binary form, first into intermediate symbols and thereafter into quantized transform coefficients along with the decoding of other encoded information). At 114, the quantized transform coefficients may be de-quantized (e.g., scaled corresponding to a scale-up factor which may be, in an example embodiment, a value specified by a multimedia standard) and then inversely transformed to obtain the residual multimedia data. At 116, the residual multimedia data may then be added (e.g., combined) with predicted blocks configured from the other information decoded along with the quantized transform coefficients to re-create the blocks of multimedia data 102.

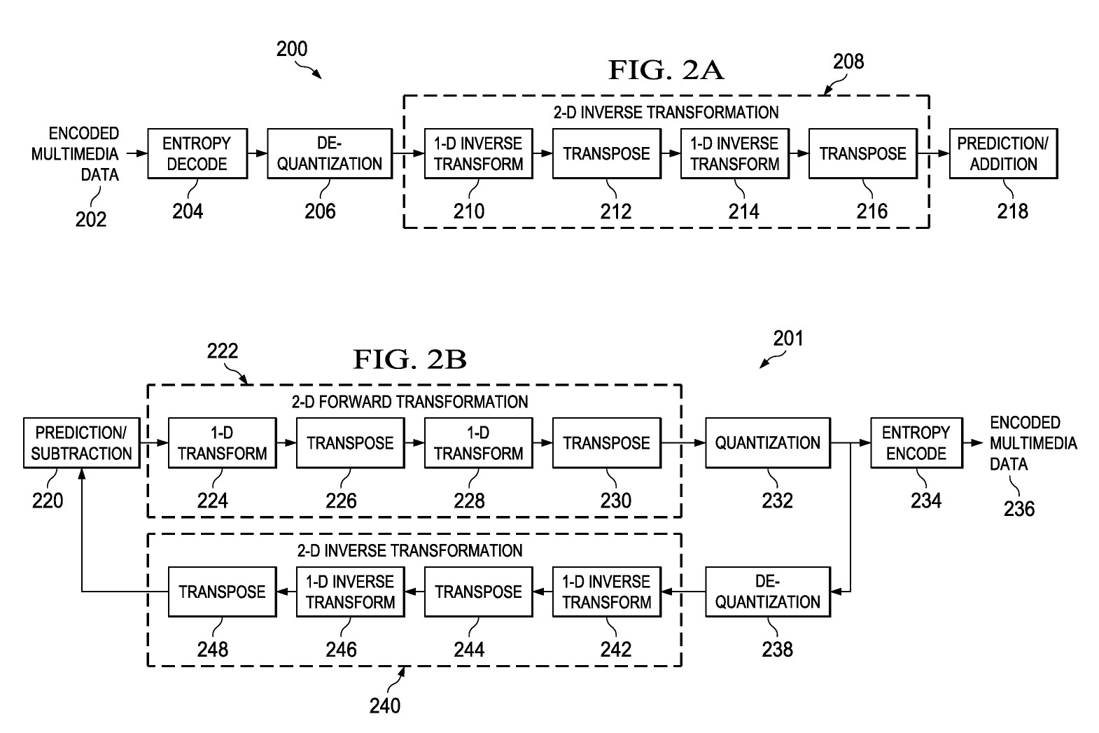

In an embodiment, the process flows 100 and 101 outlined in FIGS. 1A and 1B form the core of multimedia encoder and decoder systems, respectively. It should be noted that multimedia standards, such as video coding standards, provide specifications for implementation of the process flow for decoding, such as the process flow 101. The implementation for the process flow for encoding, such as the process flow 100, though not specified by the multimedia standards may be constructed by inversely mirroring the process flow for decoding as outlined by process flow 100 in FIG. 1A. One such exemplary implementation for a decoding process flow, as suggested by multimedia coding standards, such as H.264, and corresponding encoding process flow implementation is outlined in FIGS. 2A and 2B.

FIGS. 2A and 2B illustrate block diagrams of exemplary process flow implementations for decoding and encoding multimedia data, respectively. In particular, FIGS. 2A and 2B depict a two-dimensional (2-D) implementation of the transformation process, hereinafter referred to as 2-D transform, in the form of a cascade (or series) of two one-dimensional (1-D) transforms with a relation outlined in the following equation:

R_{m×n}=T_{m×m}·(D_{m×n}·T_{n×n}^{t})=((D_{m×n}·T_{n×n}^{t})^{t}·T_{m×m})^{t} . . . by A·B=(B^{t} A^{t})^{t}

where,
R_{m×n} denotes 2D Output Matrix and (m, n) denotes 2D transform size;
T denotes Transform Matrix;
D_{m×n} denotes Input Matrix;
· denotes dot product (multiplication); and
t denotes transpose operation
   It should be noted that a 2-D transform might be directly implemented (e.g., precluding the need to include a series of two 1-D transforms) in a circuit. However, such an implementation may not be practical as the corresponding hardware design is complicated and may occupy larger space.

FIG. 2A is a block diagram of an exemplary process flow implementation 200 for the decoding of encoded multimedia data 202. The process flow implementation 200 may be implemented by a multimedia decoder, such as a multimedia decoder explained in FIG. 1B. The process flow implementation 200 includes performing entropy decoding of received encoded multimedia data 202 at 204, de-quantization of entropy decoded multimedia data at 206, 2-D inverse transformation of the de-quantized multimedia data at 208 and prediction/addition to the inversely transformed multimedia data at 218.

The entropy decoding of the encoded multimedia data 202 involves decompression of the encoded multimedia data 202, which results in conversion from a binary form to a form comprising quantized transform coefficients. The de-quantization of the transform coefficients involves performing scaling of the quantized transform coefficients corresponding to a scale-up, factor to provide a de-quantized set of transform coefficients. Pursuant to an exemplary scenario, the set of transform coefficients may be in the form of a two-dimensional matrix of transform coefficients. As depicted in FIG. 2A, the 2-D inverse transformation may be implemented in the form of a cascade of two 1-D inverse transform steps 210, 214, with each 1-D inverse transform followed by a transpose step 212, 216. The 1-D inverse transformation of a set of transform coefficients involves conversion of transform coefficients from frequency domain data to special domain data (for example, information corresponding to each spatial location at a given point in time) while the transpose step involves interchanging (for example, swapping) rows and columns of a matrix of transform coefficients. The 2-D inverse transformation provides inversely transformed multimedia data. The prediction/addition of the inversely transformed multimedia data involves a combining of the inversely transformed multimedia data with predicted multimedia data to reconstruct the multimedia data.

FIG. 2B is a block diagram of an exemplary process flow implementation 201 for encoding multimedia data. The process flow implementation 201 may be implemented by a multimedia encoder, such as a multimedia encoder explained in FIG. 1A. The process flow implementation 201 includes performing prediction/subtraction of multimedia data at 220, 2-D forward transformation at 222, quantization of transformed multimedia data at 232, entropy encoding of quantized multimedia data at 234 to provide encoded multimedia data 236, de-quantization of transformed multimedia data post quantization at 238 and 2-D inverse transformation of inversely transformed data at 240.

The prediction/subtraction of multimedia data involves performing a prediction for portions of multimedia data (for example, inter-prediction and intra-prediction as explained herein with reference to FIG. 1A) and subsequently subtracting the predictions from the corresponding blocks to form residual samples. As depicted in FIG. 2B, the 2-D forward transform may be implemented as a cascade of 1-D transform steps 224, 228, with each 1-D transform followed by a transpose step 226, 230. Each of the 1-D transform 224, 228 performs a transformation of the residual data from a special domain to a frequency domain, thereby generating a set of transform coefficients. Pursuant to an exemplary scenario, the set of transform coefficients may be in the form of a two-dimensional matrix of transform coefficients. The transpose step involves interchanging (for example, swapping) rows and columns of matrix of transform coefficients. The 2-D forward transformation provides transformed multimedia data (e.g., multimedia data represented in a frequency domain in the form of a matrix of transform coefficients).

The quantization of the transformed multimedia data involves quantizing the transformed multimedia data (e.g., scaling the transformed multimedia data corresponding to a scale-down factor to provide further compression (with some loss of accuracy)). The entropy encoding of the quantized multimedia data involves converting the data into a binary form by using techniques such as, for example, arithmetic coding, variable length coding, and the like, to configure the encoded multimedia data, which may then be utilized for storage or transmission purposes.

The process flow implementation 201 further involves a reverse path for enabling prediction/subtraction for subsequent blocks of multimedia data. The reverse path includes de-quantization (e.g., scaling corresponding to a scale-up factor) of the quantized multimedia data and a 2-D inverse transformation of de-quantized multimedia data. As depicted in FIG. 2B, the 2-D inverse transformation may be implemented in the form of a cascade of two 1-D inverse transform steps 242, 246, with each 1-D inverse transform followed by transpose 244, 248 step. The 1-D inverse transformation of a matrix of transform coefficients involves a conversion of transform coefficients from frequency domain data to special domain data, while the transpose step involves interchanging (for example, swapping) rows and columns of a matrix of transform coefficients. The 2-D inverse transformation provides inversely transformed multimedia data in the form of residual samples. The residual samples may then be provided for prediction/subtraction so as to enable a prediction of subsequent blocks of multimedia data.

The video compression standards may specify the implementation of 2D inverse transformation in a multimedia decoder, which may be replicated on the multimedia encoder side. As the video compression standards specify a 2-D inverse transform, with a given position for implementing a transpose step, its position may not be altered, especially for integer transforms, as that may result in a mismatch between the standard specifications and its corresponding implementation. The transpose step may be implemented in the form of a transpose buffer. The transpose buffer performs an interchanging of rows and columns upon receiving information corresponding to the set of transform coefficients. Since an implementation of a next step depends upon successful completion of the transpose step, the resultant delay leads to loss in performance.

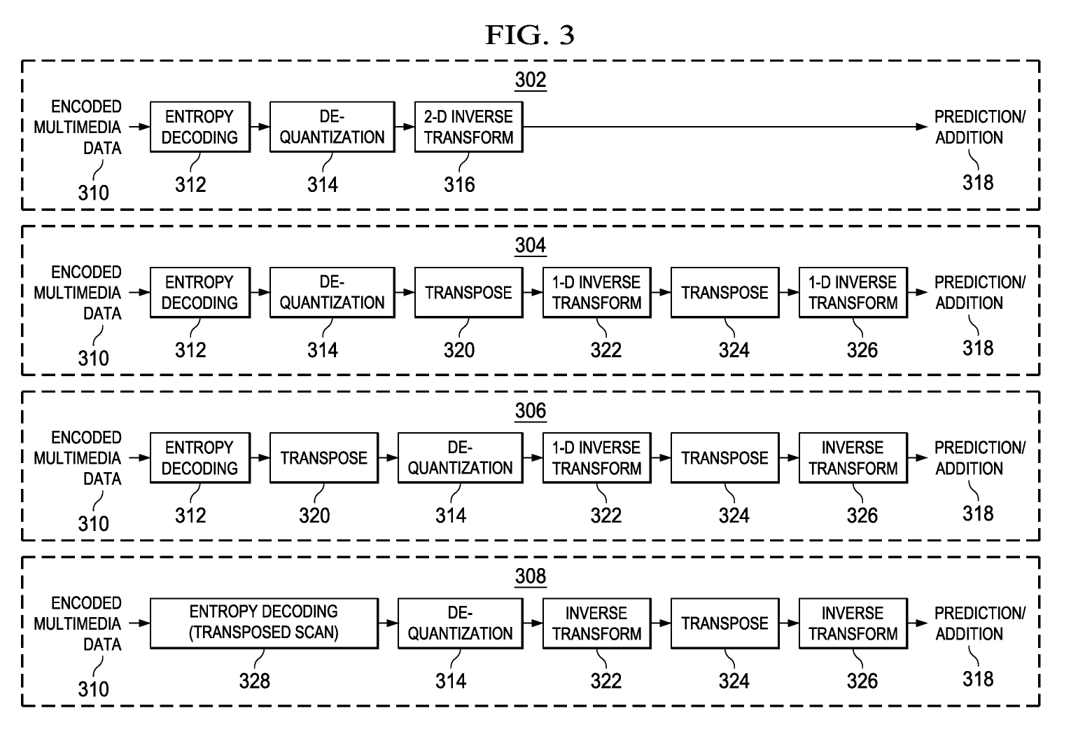

FIG. 3 illustrates variations in process flow implementations for decoding multimedia data according to an embodiment. More specifically, block 302 outlines a standard process implementation for decoding multimedia data, whereas blocks 304, 306 and 308 outline variations in a process implementation for decoding multimedia data.

The decoding process outlined in block 302 includes performing an entropy decoding of encoded multimedia data 310 at 312 to provide a decompressed set of transform coefficients, de-quantizing the set of transform coefficients at 314, performing a 2-D inverse transformation of the de-quantized set of transform co-efficients to provide inversely transformed multimedia data at 316, and performing a prediction/addition at 318 for combining intra-predicted multimedia data and/or inter-predicted multimedia data with the inversely transformed multimedia data so as to recreate the multimedia data.

The 2-D inverse transformation may be implemented as a cascade of two 1-D inverse transforms as explained herein with reference to FIG. 2A. The decoding process outlined in the block 304 provides a variation to an implementation of the decoding process outlined in FIG. 2A. In one embodiment, the order of performing the transposes 320, 324 and the 1-D inverse transforms 322, 326 is interchanged (for example, interchanged with respect to the order of performing 2D inverse transform as depicted in FIG. 2A) without affecting the decoding process, as shown in block 304. The decoding process, which may include, for example, an entropy decoding of the encoded multimedia data at 312, de-quantization of the set of transform coefficients at 314 and the 2-D transformation of the quantized set of transform coefficients, may be performed in a manner similar to that shown in the block 302.

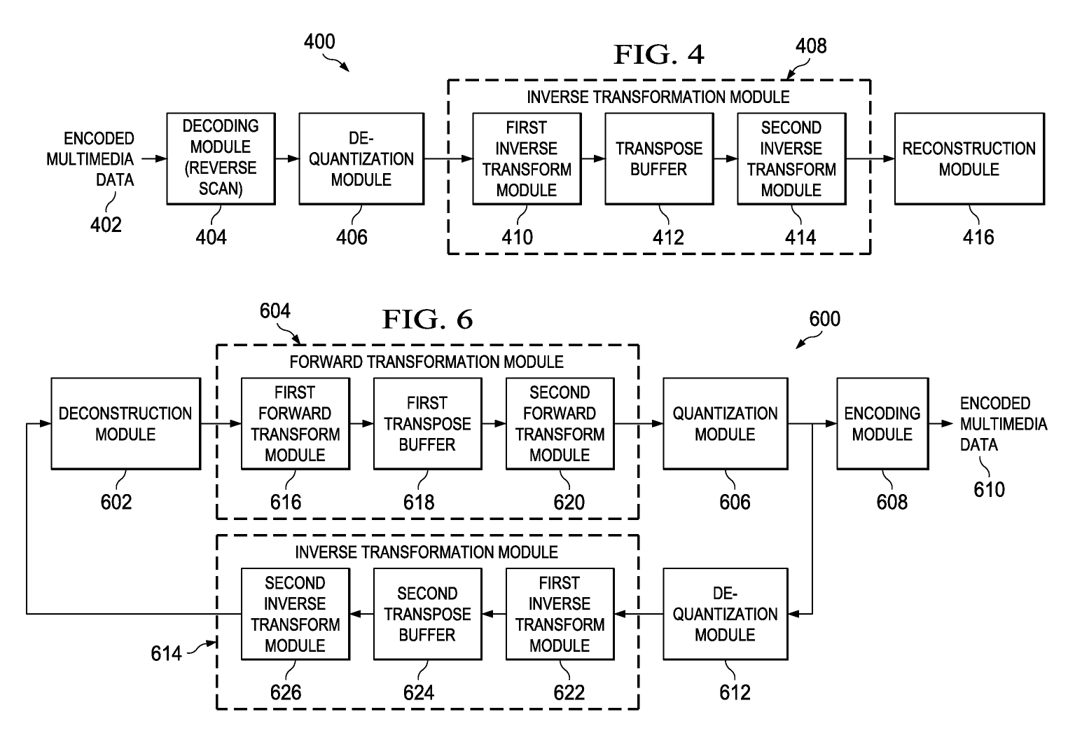

The decoding process outlined in the block 306 provides another variation to the implementation of the decoding process outlined in FIG. 2A. In one embodiment, an order of performing the transpose at 320 and de-quantization at 314 may be interchanged without affecting the decoding process, as shown in block 306. In one embodiment, the processes for entropy decoding and transpose may be combined by reversing an order of scanning during entropy decoding, as shown by the entropy decoding with a transposed scan (for example, reverse scan) at 328 in block 308. For example, if an order of scanning during entropy decoding is [X] [Y], then the order of scanning may be reversed to [Y] [X], thereby in effect performing a transpose operation post scanning during entropy decoding. Performing the decoding in the manner provided in block 308 enables the inclusion of one of the aforementioned transpose buffers to be avoided, thereby improving system performance; it also enables a saving of area and power in a system for decoding multimedia data to be achieved. It should be noted that the interchanging a position of transpose buffers as outlined in process flow implementations 304 and 306 might be feasible in infinite precision transformation processes. However, for transformation processes with finite precision, for example integer transform, the transpose buffer position may be kept fixed to the position depicted in process flow implementation outlined in block 308. An exemplary system implementing the process flow outlined in block 308 is provided in FIG. 4.

FIG. 4 is a block diagram of a system 400 for decoding multimedia data, according to an embodiment. Examples of multimedia data may include video data, image data, audio-video data, graphical data, textual data or any combinations thereof. In an embodiment, the system 400 may be a multimedia decoder. In one embodiment, the system 400 is a high efficiency video coding (HEVC) based video decoder. In another embodiment, the system 400 is one of a moving picture experts group (MPEG)-1 based video decoder, MPEG-2 based video decoder and MPEG-4 based video decoder. In an embodiment, the system 400 may be a stand-alone device or configured within a multimedia system. Examples of the multimedia systems may include, but are not limited to, (1) multimedia devices, such as cellular phones, digital video cameras and digital camcorders; (2) data processing devices, such as personal computers, laptops and personal digital assistants; and (3) consumer electronics, such as set top boxes, digital video disk (DVD) players and video network servers.

The system 400 is depicted to include a decoding module 404, a de-quantization module 406, an inverse transformation module 408, and a reconstruction module 416. The decoding module 404 may be configured to receive the encoded multimedia data 402. The encoded multimedia data 402 may be received by the decoding module 404 from a media capture device. Examples of a media capture device may include a video camera or a camcorder. The encoded multimedia data 402 may also be received from another multimedia system and/or transcoding systems, such as, for example, a stand-alone device or a part of a mobile device, such as a Smartphone, or a data processing device, such as a personal computer, a laptop device or a personal digital assistant (PDA).

The decoding module 404 is configured to decompress encoded multimedia data 402 using a pre-configurable scan order to provide a decompressed matrix of transform coefficients. In an embodiment, the decoding module 404 may be an entropy decoder and perform entropy decoding (e.g., convert the encoded multimedia data 402 from a binary form to a form representing the matrix of transform coefficients in order to decompress the encoded multimedia data 402). In one embodiment, the decoding module 404 is configured to perform one of arithmetic coding, Huffman coding and Lempel-Ziv coding to perform a decompression of the encoded multimedia data 402.

In an embodiment, a scan order associated with the decoding module 404, such as, for example, a zig-zag scan order or a raster scan order, may be pre-configurable. In an embodiment, a pre-configurable scan order of the decoding module 404 is pre-configured to be a reverse scanning order. For example, if the scanning order associated with decoding module 404 is [X] [Y] (e.g., X direction followed by Y direction in Cartesian nomenclature), then the scanning order may be reversed to [Y] [X], thereby in effect performing a transpose operation post regular scanning. Reversing the scan order in the decoding module 404 precludes the need to include a transpose buffer, thereby improving performance of the system 400.

The de-quantization module 406 is associated or communicatively associated with the decoding module 404 and the inverse transformation module 408, and is configured to de-quantize the decompressed matrix of transform coefficients. The de-quantization of the decompressed matrix of transform coefficients involves scaling the transform coefficients corresponding to a scale-up factor (for example, a value, integer or otherwise, specified by a multimedia standard).

The inverse transformation module 408 comprises a first inverse transform module 410, a transpose buffer 412 and a second inverse transform module 414. The first inverse transform module 410 is associated or communicatively associated with the decoding module 404 through the de-quantization module 406 and is configured to transform the de-quantized and decompressed matrix of transform coefficients to provide an intermediate output matrix of transform coefficients. The process of transformation involves a conversion of multimedia data from a frequency domain to a special domain. An exemplary 8×8 intermediate output matrix of transform coefficients

X comprising transform coefficients X₁₀, X₁₁ . . . X₂₀, X₂₁ . . . X₈₆, X₈₇ is depicted below:

$$X = [ \begin{matrix}{X}_{10} {X}_{11} {X}_{12} {X}_{13} {X}_{14} {X}_{15} {X}_{16} {X}_{17} \\ {X}_{20} {X}_{21} {X}_{22} {X}_{23} {X}_{24} {X}_{25} {X}_{26} {X}_{27} \\ {X}_{30} {X}_{31} {X}_{32} {X}_{33} {X}_{34} {X}_{35} {X}_{36} {X}_{37} \\ {X}_{40} {X}_{41} {X}_{42} {X}_{43} {X}_{44} {X}_{45} {X}_{46} {X}_{47} \\ {X}_{50} {X}_{51} {X}_{52} {X}_{53} {X}_{54} {X}_{55} {X}_{56} {X}_{57} \\ {X}_{60} {X}_{61} {X}_{62} {X}_{63} {X}_{64} {X}_{65} {X}_{66} {X}_{67} \\ {X}_{70} {X}_{71} {X}_{72} {X}_{73} {X}_{74} {X}_{75} {X}_{76} {X}_{77} \\ {X}_{80} {X}_{81} {X}_{82} {X}_{83} {X}_{84} {X}_{85} {X}_{86} {X}_{87}\end{matrix} ]$$

It should be noted that an 8×8 matrix is depicted for exemplary purposes, and that the intermediate output matrix of transform coefficients may include, for example, any of a 4×4, 16×16, 32×32 to 64×64 size matrices. In an example embodiment, all elements of the intermediate output matrix of transform coefficients X may have a same value. However, the value associated with transform coefficients may be changed or altered based on system requirements. In an example embodiment, the elements of the intermediate output matrix of transform coefficients X may have dissimilar values associated therewith.

The transpose buffer 412 is associated or communicatively associated with the first inverse transform module 410 and is configured to transpose (e.g., interchange) rows and columns of the intermediate output matrix of transform coefficients to provide a transposed intermediate output matrix of transform coefficients. An exemplary transposed intermediate output matrix of transform coefficients Y corresponding to the intermediate output matrix of transform coefficients X is depicted below:

$$Y = [ \begin{matrix}{X}_{10} {X}_{20} {X}_{30} {X}_{40} {X}_{50} {X}_{60} {X}_{70} {X}_{80} \\ {X}_{11} {X}_{21} {X}_{31} {X}_{41} {X}_{51} {X}_{61} {X}_{71} {X}_{81} \\ {X}_{12} {X}_{22} {X}_{32} {X}_{42} {X}_{52} {X}_{62} {X}_{72} {X}_{82} \\ {X}_{13} {X}_{23} {X}_{33} {X}_{43} {X}_{53} {X}_{63} {X}_{73} {X}_{83} \\ {X}_{14} {X}_{24} {X}_{34} {X}_{44} {X}_{54} {X}_{64} {X}_{74} {X}_{84} \\ {X}_{15} {X}_{25} {X}_{35} {X}_{45} {X}_{55} {X}_{65} {X}_{75} {X}_{65} \\ {X}_{16} {X}_{26} {X}_{36} {X}_{46} {X}_{56} {X}_{66} {X}_{76} {X}_{86} \\ {X}_{17} {X}_{27} {X}_{37} {X}_{47} {X}_{57} {X}_{67} {X}_{77} {X}_{87}\end{matrix} ]$$

The second inverse transform module 414 is associated or communicatively associated with the transpose buffer 412 and is configured to transform the transposed intermediate output matrix of transform coefficients to provide inversely transformed multimedia data. The second inverse transform module 414 converts the matrix of transform coefficients into special domain data (e.g., inversely transformed multimedia data). In an embodiment, each of the first inverse transform module and the second inverse transform module is configured to perform at least one of a 1-D Inverse Discrete Cosine Transform (IDCT), a 1-D Inverse Discrete Sine Transform (IDST), a 1-D Inverse Karhunen-Loève Transform (IKLT) and a 1-D Hadamard transform.

The reconstruction module 416 is associated or communicatively associated with the second inverse transform module 414 and is configured to combine inversely transformed multimedia data with at least one of inter-predicted multimedia data and intra-predicted multimedia data to reconstruct the multimedia data. As explained herein with reference to FIGS. 1A and 1B, blocks of multimedia data within each frame of multimedia data may be predicted based on prior encoded blocks within the same frame (e.g., intra-prediction) and/or from previous frames (e.g., inter-prediction). These predicted blocks are subtracted from multimedia data to be encoded, and the residual multimedia data is encoded and stored/transmitted. Upon or subsequent to the decoding of the multimedia data, the residual multimedia data is combined with the predicted blocks in order to reconstruct the multimedia data at the reconstruction block 416.

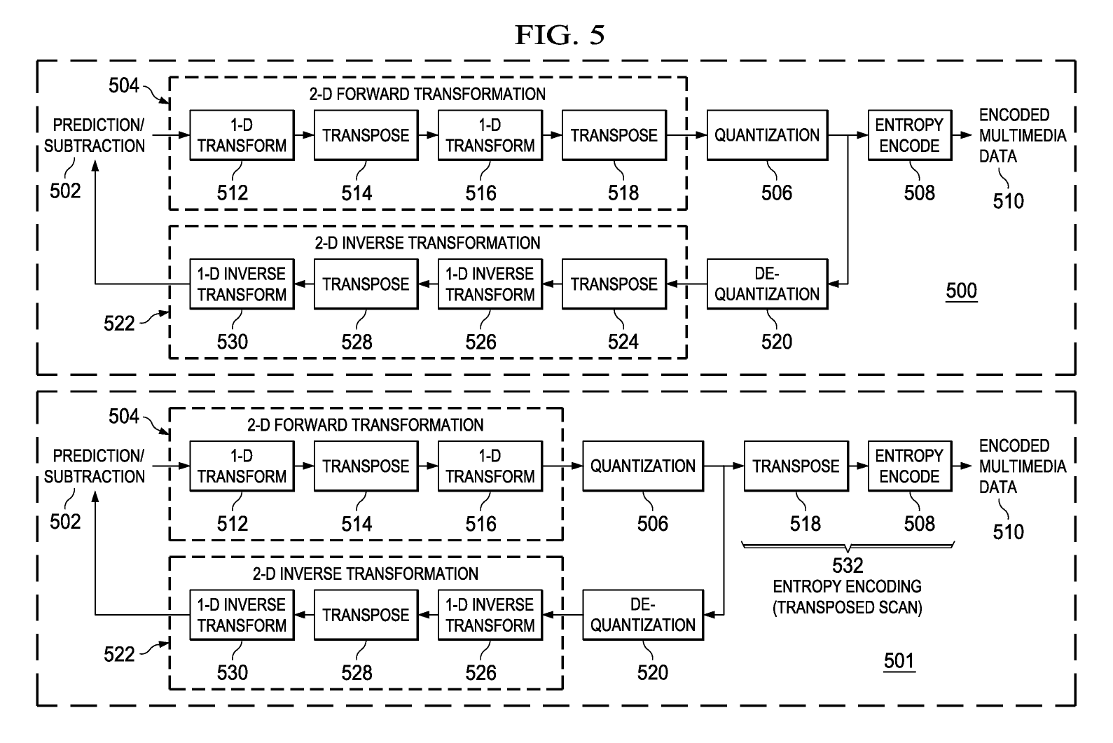

FIG. 5 illustrates variations in process implementations for encoding multimedia data according to an embodiment. More specifically, blocks 500 and 501 outline variations from a standard process implementation for encoding multimedia data comprising (1) a 2D forward transform that comprises two 1-D transforms, with each 1-D transform followed by a transpose operation in a forward path, and (2) a 2D inverse transform that comprises two 1-D inverse transforms, with each 1-D inverse transform followed by a transpose operation in a reverse path.

The encoding process outlined in block 500 includes performing prediction/subtraction of multimedia data to generate residual multimedia data for encoding at 502, a 2D forward transformation of residual multimedia data to provide a set of transform coefficients at 504, quantization of the set of transform coefficients at 506, and entropy encoding of quantized transform coefficients at 508 to provide encoded multimedia data 510. The encoding process outlined in block 500 also includes a reverse path comprising de-quantization of quantization of transformed multimedia data at 520 and a 2D inverse transformation of transformed multimedia data at 522 for generating inversely transformed multimedia data in the form of residual multimedia data, which may be provided for prediction/subtraction of subsequent blocks of multimedia data.

Each of the 2-D forward transformation and the 2-D inverse transformation is implemented as a cascade of two 1-D transforms, as explained herein with reference to FIG. 2B. In block 500, the 2-D forward transformation 504 includes two 1-D forward transforms (also referred herein as 1-D transforms) 512, 516, with each 1-D transform operation followed by a transpose operation 514, 518. Similarly, the 2-D inverse transformation 522 includes two 1-D inverse transforms 526, 530, with each 1-D transform operation preceded by a transpose operation 524, 528.

The encoding process outlined in the block 500 provides a variation to the implementation of the encoding process outlined in FIG. 2B. In one embodiment, the order of performing the transpose operation and the 1-D inverse transform may be interchanged (for example, interchanged from the process flow order depicted in FIG. 2B), as depicted at 522 without affecting the encoding process. In an embodiment, a number of the transpose operations (518 and 524) may be combined and positioned after the quantization operation at 506 as transpose operation 518 without affecting the encoding process, as shown in block 501. In one embodiment, the processes for entropy encoding and transpose may be combined by reversing an order of the scanning, i.e. transposed scanning, during entropy encoding, as shown at 532 in block 501. For example, if an order of scanning during entropy encoding is [X] [Y], then the order of scanning may be reversed to [Y] [X], thereby in effect performing a transpose operation prior to scanning during the entropy encoding. The performance of encoding in such a manner enables the inclusion of one transpose buffer to be avoided, in both forward and reverse paths, thereby improving system performance and providing a savings of area and power in a system for encoding multimedia data. An exemplary system implementing the process flow outlined in block 501 is provided in FIG. 6.

FIG. 6 is a block diagram of a system 600 for encoding multimedia data according to an embodiment. Examples of multimedia data may include video data, image data, audio-video data, graphical data, textual data and any combinations thereof. In an embodiment, the system 600 may be a multimedia encoder. In one embodiment, the system 600 is a high efficiency video coding (HEVC) based video encoder. In another embodiment, the system 600 is one of a moving picture experts group (MPEG)-1 based video encoder, MPEG-2 based video encoder and MPEG-4 based video encoder. In an embodiment, the system 600 may be a stand-alone device or configured within a multimedia system. Examples of the multimedia systems may include, but are not limited to, (1) multimedia devices, such as cellular phones, digital video cameras and digital camcorders; (2) data processing devices, such as personal computers, laptops and personal digital assistants; and (3) consumer electronics, such as set top boxes, digital video disk (DVD) players and video network servers.

The system 600 is depicted to include a deconstruction module 602, forward transformation module 604, quantization module 606, encoding module 608, de-quantization module 612 and an inverse transformation module 614. The deconstruction module 602 may be configured to receive multimedia data to be encoded. The multimedia data may be received by the deconstruction module 602 from a media capture device. Examples of a media capture device may include a video camera or a camcorder. The encoded multimedia data may also be received from another multimedia system and/or transcoding systems, such as, for example, a stand-alone device, or a part of a mobile device, such as, for example, a Smartphone, or a data processing device, such as, for example, a personal computer, a laptop device or a personal digital assistant (PDA).

The deconstruction module 602 may be configured to generate a prediction for each block of multimedia data to be encoded based on inter-prediction and intra-prediction and subtract the predicted blocks from the blocks of multimedia data to be encoded to form residual multimedia data for encoding. The residual multimedia data may be provided to the forward transformation module 604. The forward transformation module 604 comprises a first forward transform module 616, a first transpose buffer 618 and a second forward transform module 620. The forward transformation module 604 is configured to transform multimedia data (e.g., residual multimedia data) to provide an intermediate input matrix of transform coefficients. The process of transformation involves a conversion of multimedia data from a special domain to a frequency domain in the form of transform coefficients. An exemplary form of the intermediate input matrix of transform coefficients may be similar to matrix X as explained herein with reference to FIG. 4.

The first transpose buffer 618 is associated or communicatively associated with the first forward transform module 616 and is configured to transpose the intermediate input matrix of transform coefficients to provide a transposed intermediate input matrix of transform coefficients. The transpose operation (e.g., interchanging of the rows and columns of the matrix) may be performed as explained herein with reference to FIG. 4 (for example, conversion of matrix X to matrix Y).

The second transformation module 620 is associated or communicatively associated with the first transpose buffer 618 and is configured to transform the transposed intermediate matrix of transform coefficients to provide transformed multimedia data. In an embodiment, each of the first forward transform module 616 and the second forward transform module 620 is configured to perform at least one of a 1-D Discrete Cosine Transform (DCT), a 1-D Discrete Sine Transform (DST), a 1-D Karhunen-Loève Transform (KLT) and a 1-D Hadamard transform.

The quantization module 606 is associated or communicatively associated with the second forward transform module 620 and is configured to quantize the transformed multimedia data. The process of quantization involves scaling each transform coefficient corresponding to a scale-down factor which may be a mathematical reciprocal of the scale-up factor specified by a multimedia standard, effectively reducing some transform coefficients to a small value (including zero value), to provide compression.

The encoding module 608 is associated or communicatively associated with the forward transformation module 604 through the quantization module 606 and is configured to compress the transformed multimedia data using a pre-configurable scan order to provide a compressed matrix of transform coefficients. In an embodiment, the encoding module 608 may be an entropy encoder and perform entropy encoding (e.g., convert the transformed multimedia data into a binary form for compression purposes), thereby configuring the encoded multimedia data 610. In one embodiment, the encoding module 608 is configured to perform one of arithmetic coding, Huffman coding and Lempel-Ziv coding to perform compression of the transformed multimedia data.

In an embodiment, a scan order associated with encoding module 608 (for example, a zig-zag scan order or a raster scan order) may be pre-configurable. In an embodiment, a pre-configurable scan order of the encoding module is pre-configured to be a reverse scanning order. For example, if the scanning order associated with encoding module 608 is [X] [Y] (e.g., X direction followed by Y direction in Cartesian nomenclature), then the scanning order may be reversed to [Y] [X], thereby in effect performing a transpose operation prior to a regular scanning. Reversing the scan order in the encoding module 608 enables the inclusion of one transpose buffer, in each forward and reverse paths to be avoided, thereby improving performance of the system 600.

The de-quantization module 612 is associated or communicatively associated with the quantization module 606 and is configured to de-quantize a quantization of transformed multimedia data to provide de-quantized multimedia data. The process of de-quantization involves scaling of quantized multimedia data corresponding to a scale-up factor, which may be, in an example embodiment, a value, integer or otherwise, specified by a multimedia standard. The inverse transformation module 614 comprises a first inverse transform module 622, a second transpose buffer 624 and a second inverse transform module 626. The first inverse transform module 622 is associated or communicatively associated with the de-quantization module 612 and is configured to inversely transform the de-quantized multimedia data to provide an intermediate output matrix of transform coefficients (such as intermediate output matrix of transform coefficients X explained herein with reference to FIG. 4). The inverse transformation converts the matrix of transform coefficients from frequency domain data into special domain data. The second transpose buffer 624 is configured to transpose the intermediate output matrix of transform coefficients to provide a transposed intermediate output matrix of transform coefficients. The second inverse transform module 626 is configured to transform the transposed intermediate output matrix to provide inversely transformed multimedia data. In an embodiment, each of the first inverse transform module 622 and the second inverse transform module 626 is configured to perform at least one of a 1-D Inverse Discrete Cosine Transform (IDCT), a 1-D Inverse Discrete Sine Transform (IDST), a 1-D Inverse Karhunen-Loève Transform (IKLT) and a 1-D Hadamard transform.

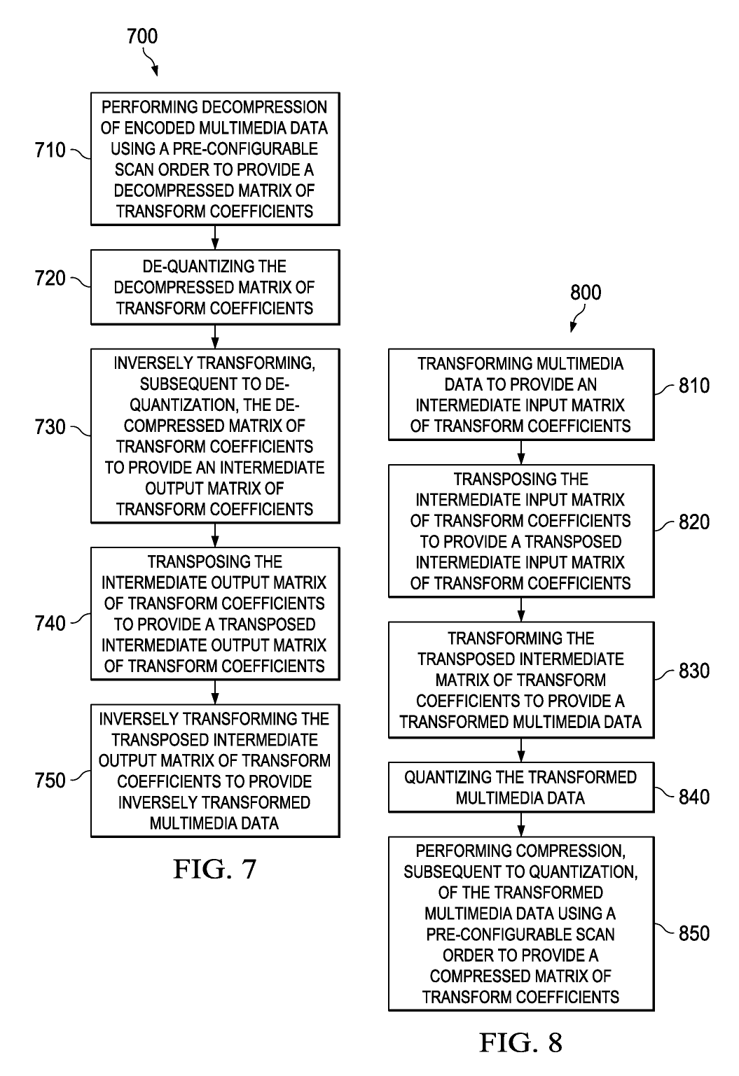

FIG. 7 is a flow diagram of a method 700 for decoding multimedia data according to an embodiment. The method 700 starts at operation 710. At operation 710, decompression of encoded multimedia data using a pre-configurable scan order is performed (for example, by the decoding module of FIG. 4) to provide a decompressed matrix of transform coefficients. In an embodiment, the decompression may involve entropy decoding (e.g., converting the encoded multimedia data from a binary form to a form representing the matrix of transform coefficients). In one embodiment, performing decompression comprises performing one of arithmetic coding, Huffman coding and Lempel-Ziv coding on the encoded multimedia data.

In an embodiment, a pre-configurable scan order is pre-configured to be a reverse scanning order. For example, if the scanning order for a zig-zag scan or a raster scan during decompression is [X] [Y] (e.g., X direction followed by Y direction in Cartesian nomenclature), then the scanning order may be reversed to [Y] [X], thereby in effect performing a transpose operation post regular scanning. Reversing the scan order enables the implementation of one transpose operation to be avoided, thereby improving overall performance.

At operation 720, the decompressed matrix of transform coefficients is de-quantized. The de-quantization of the decompressed matrix of transform coefficients involves scaling the transform coefficients corresponding to a scale-up factor (for example, a value, integer or otherwise specified by a multimedia standard).

At operation 730, decompressed matrix of transform coefficients, subsequent to de-quantization, is inversely transformed to provide an intermediate output matrix of transform coefficients. The process of transformation involves conversion of multimedia data from a frequency domain to a special domain. An exemplary 8×8 intermediate output matrix of transform coefficients, such as matrix X explained herein with reference to FIG. 4, may be generated based on an inverse transformation of de-quantized and decompressed matrix of transform coefficients. It should be noted that the intermediate output matrix'of transform coefficients may be of a different size, such as, for example 4×4, 8×8, 16×16, 32×32 to 64×64 size matrices.

At operation 740, the intermediate output matrix of transform coefficients is transposed to provide a transposed intermediate output matrix of transform coefficients. The transpose operation involves interchanging rows and columns of the intermediate output matrix of transform coefficients to provide a transposed intermediate output matrix of transform coefficients. An example of the intermediate output matrix of transform coefficients may be a transposed intermediate output matrix of transform coefficients Y as explained herein with reference to FIG. 4.

At operation 750, the transposed intermediate output matrix is inversely transformed to provide inversely transformed multimedia data. Inversely transforming the transposed intermediate output matrix converts the matrix of transform coefficients into special domain data (e.g., inversely transformed multimedia data). In an embodiment, performing inverse transformation comprises performing at least one of a 1-D Inverse Discrete Cosine Transform (IDCT), a 1-D Inverse Discrete Sine Transform (IDST), a 1-D Karhunen-Loève Transform (KLT) and a 1-D Hadamard transform.

In an embodiment, the method 700 further includes combining inversely transformed multimedia data with at least one of inter-predicted multimedia data and intra-predicted multimedia data to reconstruct the multimedia data. As explained in FIGS. 1A and 1B, blocks of multimedia data within each frame of multimedia data may be predicted based on prior encoded blocks within the same frame (e.g., intra-prediction) and from previous frames (e.g., inter-prediction). These predicted blocks are subtracted from multimedia data to be encoded and the residual data is encoded and stored/transmitted. Upon the decoding of the multimedia data, the residual data is then combined with the predicted blocks to reconstruct the multimedia data.

FIG. 8 is a flow diagram of a method 800 for encoding multimedia data according to an embodiment. The method 800 starts at operation 810. At operation 810, multimedia data is transformed to provide an intermediate input matrix of transform coefficients. In an embodiment, at least one of inter-predicted multimedia data and intra-predicted multimedia data is subtracted from the multimedia data to be encoded and residual multimedia data is utilized for transformation into the intermediate input matrix of transform coefficients. The process of transformation involves a conversion of multimedia data from a special domain to a frequency domain in the form of transform coefficients. An exemplary form of the intermediate input matrix of transform coefficients may be similar to matrix X explained herein with reference to FIG. 4.

At operation 820, the intermediate input matrix of transform coefficients is transposed to provide a transposed intermediate input matrix of transform coefficients. The transpose operation involves an interchanging of the rows and columns of the intermediate input matrix of transform coefficients and may be performed as explained herein with reference to FIG. 4 (for example, conversion of matrix X to matrix Y).

At operation 830, the transposed intermediate matrix of transform coefficients is transformed to provide transformed multimedia data. In an embodiment, performing a transpose operation comprises performing at least one of a 1-D Discrete Cosine Transform (DCT), a 1-D Discrete Sine Transform (DST), a 1-D Karhunen-Loève Transform (KLT) and a 1-D Hadamard transform.

At operation 840, the transformed multimedia data is quantized. The process of quantization involves scaling each transform coefficient corresponding to a scale-down factor, which may be a mathematical reciprocal of the scale-up factor specified by a multimedia standard, effectively reducing some transform coefficients to a small value (including zero value), to thereby provide compression.

At operation 850, compression of the transformed multimedia data, subsequent to quantization, is performed using a pre-configurable scan order to provide a compressed matrix of transform coefficients. In an embodiment, performing compression may involve performing entropy encoding (e.g., converting the transformed multimedia data into a binary form), thereby configuring the encoded multimedia data. In one embodiment, performing compression may involve performing one of arithmetic coding, Huffman coding and Lempel-Ziv coding to perform compression of the transformed multimedia data.

In an embodiment, a pre-configurable scan order is pre-configured to be a reverse scanning order. For example, if the scanning order associated with entropy decoding is [X] [Y] (e.g., X direction followed by Y direction in Cartesian nomenclature), then the scanning order may be reversed to [Y] [X], thereby in effect performing a transpose operation prior to regular scanning. Reversing the scan order enables the implementation of one transpose buffer to be avoided, thereby improving overall performance. In an embodiment, the methods 700 and 800 as explained herein may be implemented by a data processing device, such as for example, a computer.

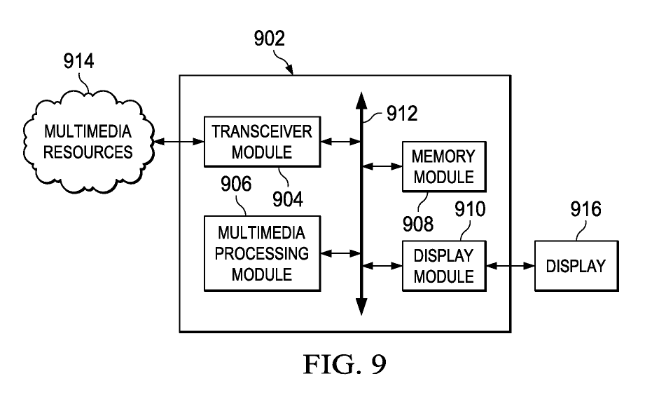

FIG. 9 is a block diagram of a integrated circuit 902 for decoding and encoding multimedia data, according to an embodiment. The integrated circuit 902 comprises a transceiver module 904, a multimedia processing module 906, a memory module 908 and a display module 910. The transceiver module 904, the multimedia processing module 906, the memory module 908 and the display module 908 are communicatively associated with each other using data path 912.

The transceiver module 904 is communicatively associated with a plurality of multimedia resources 914 and is configured to receive multimedia data from one or more multimedia resources from among the plurality of multimedia resources 914. Examples of the multimedia resources may include, but are not limited to (1) remote multimedia systems, (2) media capture devices like camera, camcorders and the like, and (3) multimedia storage devices like magnetic tapes, disks, computer readable media and the like. In an embodiment, the transceiver module 904 may include an antenna and/or network connectors to connect to wired networks (for example, local area networks (LANs)) and wireless networks (for example, cellular networks) or combination thereof (for example, internet). Examples of network connectors may include a universal serial bus (USB) interface, a wireless LAN interface, an infrared interface, an Ethernet port and the like.

The multimedia processing module 906 is configured to perform at least one of encoding of multimedia data and decoding of encoded multimedia data. In an embodiment, the transceiver module 904 may be configured to receive the multimedia data in encoded form and provide the encoded multimedia data to the multimedia processing module 906. The multimedia processing module 906 may be configured to decode the encoded multimedia data and provide the decoded multimedia media to the memory module 908 for storing or to the display module 910 for displaying multimedia media on a display 916. In an embodiment, the multimedia processing module 906 may be configured to encode the multimedia data and provide the multimedia data to transceiver module 904 for transmission purposes or to memory module 908 for storage purposes. In an embodiment, the multimedia processing module 906 may be configured to include components of system 400 explained in FIG. 4 and/or system 600 explained in FIG. 6. For example, the multimedia processing module 906 may include components of system 400 such as the decoding module 404, the de-quantization module 406, the reconstruction module 416 and the inverse transformation module 408 including the first inverse transform module 410, the transpose buffer 412 and the second inverse transform module 414, and/or, the components of system 600, such as the deconstruction module 602, the forward transformation module 604, the quantization module 606, the encoding module 608, the de-quantization module 612 and the inverse transformation module 614. The components of the system 400 and/or system 600 within the multimedia processing module 906 and configured to perform functions as discussed in FIG. 4 and FIG. 6 respectively are not repeated herein for sake of brevity.

The memory module 908 is configured to store the multimedia data subsequent to one of encoding of multimedia data and decoding of multimedia data. Examples of memory module 908 may include, but are not limited to, random access memory (RAM), dual port RAM, synchronous dynamic RAM (SDRAM), double data rate SDRAM (DDR SDRAM), and the like. The display module 910 is configured to facilitate display of the multimedia data on display 916. The display may be facilitated, for example, in response to a user input received using a user interface (not shown in FIG. 9). Examples of display 916 may include a light crystal display (LCD) panel, a plasma display panel, a field emission display and the like.

In an embodiment the integrated circuit 902 may be an application processor chip. In an embodiment, the integrated circuit 902 may be a part of general processor chip embedded within a multimedia system. Examples of the multimedia systems may include, but are not limited to, (1) multimedia devices, such as cellular phones, digital video cameras and digital camcorders; (2) data processing devices, such as personal computers, laptops and personal digital assistants; and (3) consumer electronics, such as set top boxes, digital video disk (DVD) players and video network servers.

Without in any way limiting the scope, interpretation, or application of the claims appearing below, advantages of one or more of the exemplary embodiments disclosed herein include decoding and encoding multimedia data such that the implementation of one additional transpose buffer (during decoding multimedia data) and two transpose buffers (during encoding multimedia data) may be avoided, thereby reducing a delay in processing and increasing an overall performance of the system.

Although the present technology has been described with reference to specific exemplary embodiments, it is noted that various modifications and changes may be made to these embodiments without departing from the broad spirit and scope of the present technology. For example, the various systems, modules, etc., described herein may be enabled and operated using hardware circuitry (e.g., complementary metal oxide semiconductor (CMOS) based logic circuitry), firmware, software and/or any combination of hardware, firmware, and/or software (e.g., embodied in a machine readable medium). For example, the various modules and methods may be embodied using transistors, logic gates, and electrical circuits (e.g., application specific integrated circuit (ASIC) circuitry and/or in Digital Signal Processor (DSP) circuitry).

Particularly, the system 400 of FIG. 4, which comprises the decoding module 404, de-quantization module 406, inverse transformation module 408, first inverse transform module 410, transpose buffer 412, second inverse transform module 414 and reconstruction module 416, and/or system 600 of FIG. 6, which comprises the deconstruction module 602, forward transformation module 604, quantization module 606, encoding module 608, and inverse transformation module 612, may be enabled using software and/or using transistors, logic gates, and electrical circuits (e.g., integrated circuit circuitry such as ASIC circuitry).

Embodiments of the present disclosure include one or more computer programs stored or otherwise embodied on a computer-readable medium, wherein the computer programs are configured to cause a processor to perform one or more operations, such as for example, operations 710-750 for method 700 or operations 810-850 for method 800. A computer-readable medium storing, embodying, or encoded with a computer program, or similar language, may be embodied as a tangible data storage device storing one or more software programs that are configured to cause a processor to perform one or more operations. Such operations may be, for example, any of the steps or operations described herein. Additionally, a tangible data storage device may be embodied as one or more volatile memory devices, one or more non-volatile memory devices, and/or a combination of one or more volatile memory devices and non-volatile memory devices.

Also, techniques, subsystems and methods described and illustrated in the various embodiments as discrete or separate may be combined or integrated with other systems, modules, techniques, or methods without departing from the scope of the present technology. Other items shown or discussed as directly communicatively associated or communicating with each other may be communicatively associated through some interface or device, such that the items may no longer be considered directly communicatively associated with each other but may still be indirectly communicatively associated and in communication, whether electrically, mechanically, or otherwise, with one another. Other examples of changes, substitutions, and alterations ascertainable by one skilled in the art, upon studying the exemplary embodiments disclosed herein, may be made without departing from the spirit and scope of the present technology.

It should be noted that reference throughout this specification to features, advantages, or similar language does not imply that all of the features and advantages should be or are in any single embodiment. Rather, language referring to the features and advantages may be understood to mean that a specific feature, advantage, or characteristic described in connection with an embodiment may be included in at least one embodiment of the present technology. Thus, discussions of the features and advantages, and similar language, throughout this specification may, but do not necessarily, refer to the same embodiment.

Various embodiments of the present disclosure, as discussed above, may be practiced with steps and/or operations in a different order, and/or with hardware elements in configurations which are different than those which are disclosed. Therefore, although the technology has been described based upon these exemplary embodiments, it is noted that certain modifications, variations, and alternative constructions may be apparent and well within the spirit and scope of the technology.

Although various exemplary embodiments of the present technology are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A system for decoding multimedia data, the system comprising:
a decoding module configured to decompress encoded multimedia data using a pre-configurable scan order to provide a decompressed matrix of transform coefficients; and
an inverse transformation module comprising:
a first inverse transform module communicatively associated with the decoding module and configured to inversely transform the decompressed matrix of transform coefficients to provide an intermediate output matrix of transform coefficients,
a transpose buffer communicatively associated with the first inverse transform module and configured to transpose the intermediate output matrix of transform coefficients to provide a transposed intermediate output matrix of transform coefficients, and
a second inverse transform module communicatively associated with the transpose buffer and configured to inversely transform the transposed intermediate output matrix of transform coefficients to provide inversely transformed multimedia data.

2. The system of claim 1, further comprising:
a de-quantization module communicatively associated with the decoding module and the inverse transformation module and configured to de-quantize the decompressed matrix of transform coefficients prior to an inverse transformation of the decompressed matrix of transform coefficients into the intermediate output matrix of transform coefficients.

3. The system of claim 1, wherein the pre-configurable scan order of the decoding module is pre-configured to be a reverse scanning order.

4. The system of claim 1, wherein:
the decoding module is configured to perform one of arithmetic coding, Huffman coding and Lempel-Ziv coding to decompress the encoded multimedia data; and
each of the first inverse transform module and the second inverse transform module is configured to perform at least one of a one-dimensional (1-D) Inverse Discrete Cosine Transform (IDCT), a 1-D Inverse Discrete Sine Transform (IDST), a 1-D Inverse Karhunen-Loève Transform (IKLT) and a 1-D Hadamard transform.

5. The system of claim 1, wherein the system is one of a high efficiency video coding (HEVC) based decoder, a moving picture experts group (MPEG)-1 based decoder, MPEG-2 based decoder and MPEG-4 based decoder.

6. The system of claim 1, further comprising:
a reconstruction module communicatively associated with the second inverse transform module and configured to reconstruct multimedia data by combining the inversely transformed multimedia data with at least one of inter-predicted multimedia data and intra-predicted multimedia data.

7. A system for encoding multimedia data, the system comprising:
a forward transformation module comprising:
a first forward transform module configured to transform multimedia data to provide an intermediate input matrix of transform coefficients,
a first transpose buffer communicatively associated with the first forward transform module and configured to transpose the intermediate input matrix of transform coefficients to provide a transposed intermediate input matrix of transform coefficients, and
a second forward transform module communicatively associated with the first transpose buffer and configured to transform the transposed intermediate input matrix of transform coefficients to provide transformed multimedia data; and
an encoding module communicatively associated with the forward transformation module and configured to compress the transformed multimedia data using a pre-configurable scan order to provide a compressed matrix of transform coefficients.

8. The system of claim 7, further comprising:
a quantization module communicatively associated with the forward transformation module and the encoding module and configured to quantize the transformed multimedia data prior to a compression of the transformed multimedia data.

9. The system of claim 8, further comprising:
a de-quantization module communicatively associated with the quantization module and configured to de-quantize a quantization of the transformed multimedia data to provide de-quantized multimedia data; and
an inverse transformation module comprising:
a first inverse transform module communicatively associated with the de-quantization module and configured to inversely transform the de-quantized multimedia data to provide an intermediate output matrix of transform coefficients,
a second transpose buffer communicatively associated with the first inverse transform module and configured to transpose the intermediate output matrix of transform coefficients to provide a transposed intermediate output matrix of transform coefficients, and
a second inverse transform module communicatively associated with the second transpose buffer and configured to inversely transform the transposed intermediate output matrix of transform coefficients to provide inversely transformed multimedia data.

10. The system of claim 7, wherein the pre-configurable scan order of the encoding module is pre-configured to be a reverse scanning order.

11. The system of claim 7, wherein:
the encoding module is configured to perform one of arithmetic coding, Huffman coding and Lempel-Ziv coding to compress the transformed multimedia data; and
each of the first forward transform module and the second forward transform module is configured to perform at least one of a 1-D Discrete Cosine Transform (DCT), a 1-D Discrete Sine Transform (DST), a 1-D Karhunen-Loève Transform (KLT) and a 1-D Hadamard transform.

12. The system of claim 7, wherein the system is one of a high efficiency video coding (HEVC) based encoder, MPEG-1 based encoder, MPEG-2 based encoder and MPEG-4 based encoder.

13. The system of claim 7, further comprising:
a de-construction module communicatively associated with the first forward transform module and configured to subtract at least one of inter-predicted multimedia data and intra-predicted multimedia data from multimedia data to be encoded and provide residual multimedia data to the first forward transform module for a transformation into the intermediate input matrix of transform coefficients.

14. A computer implemented method of decoding multimedia data, the method comprising:
performing a decompression of encoded multimedia data using a pre-configurable scan order to provide a decompressed matrix of transform coefficients;
inversely transforming the decompressed matrix of transform coefficients to provide an intermediate output matrix of transform coefficients;
transposing the intermediate output matrix of transform coefficients to provide a transposed intermediate output matrix of transform coefficients; and
inversely transforming the transposed intermediate output matrix of transform coefficients to provide inversely transformed multimedia data.

15. The computer implemented method of claim 14, wherein the pre-configurable scan order is pre-configured to be a reverse scanning order.

16. The computer implemented method of claim 14, wherein:
performing the decompression comprises performing one of arithmetic coding, Huffman coding and Lempel-Ziv coding on the encoded multimedia data; and
performing an inverse transformation comprises performing at least one of a 1-D Inverse Discrete Cosine Transform (IDCT), a 1-D Inverse Discrete Sine Transform (IDST), a 1-D Inverse Karhunen-Loève Transform (IKLT) and a 1-D Hadamard transform.

17. A computer implemented method of encoding multimedia data, the method comprising:
transforming multimedia data to provide an intermediate input matrix of transform coefficients;
transposing the intermediate input matrix of transform coefficients to provide a transposed intermediate input matrix of transform coefficients;
transforming the transposed intermediate input matrix of transform coefficients to provide transformed multimedia data; and
performing a compression of the transformed multimedia data using a pre-configurable scan order to provide a compressed matrix of transform coefficients.

18. The computer implemented method of claim 17, further comprising:
quantizing the transformed multimedia data prior to performing the compression of the transformed multimedia data.

19. The computer implemented method of claim 18, further comprising:
de-quantizing a quantization of the transformed multimedia data to provide de-quantized multimedia data;
inversely transforming the de-quantized multimedia data to provide an intermediate output matrix of transform coefficients;
transposing the intermediate output matrix of transform coefficients to provide a transposed intermediate output matrix of transform coefficients; and
inversely transforming the transposed intermediate output matrix of transform coefficients to provide inversely transformed multimedia data.

20. The computer implemented method of claim 17, wherein the pre-configurable scan order is pre-configured to be a reverse scanning order.

21. An integrated circuit comprising:
a transceiver module communicatively associated with a plurality of multimedia resources and configured to receive multimedia data from at least one multimedia resource from among the plurality of multimedia resources;
a multimedia processing module communicatively associated with the transceiver module and configured to perform at least one of encoding of multimedia data and decoding of encoded multimedia data; and
a memory module communicatively associated with the transceiver module and the multimedia processing module and configured to store the multimedia data subsequent to one of encoding of multimedia data and decoding of multimedia data.

22. The integrated circuit of claim 21, wherein the multimedia processing module comprises:
a decoding module configured to decompress encoded multimedia data using a pre-configurable scan order to provide a decompressed matrix of transform coefficients; and
an inverse transformation module comprising:
a first inverse transform module communicatively associated with the decoding module and configured to inversely transform the decompressed matrix of transform coefficients to provide an intermediate output matrix of transform coefficients,
a transpose buffer communicatively associated with the first inverse transform module and configured to transpose the intermediate output matrix of transform coefficients to provide a transposed intermediate output matrix of transform coefficients, and
a second inverse transform module communicatively associated with the transpose buffer and configured to inversely transform the transposed intermediate output matrix of transform coefficients to provide inversely transformed multimedia data.

23. The integrated circuit of claim 22, wherein the pre-configurable scan order of the decoding module is pre-configured to be a reverse scanning order

24. The integrated circuit of claim 21, wherein the multimedia processing module comprises:
a forward transformation module comprising:
a first forward transform module configured to transform multimedia data to provide an intermediate input matrix of transform coefficients,
a first transpose buffer communicatively associated with the first forward transform module and configured to transpose the intermediate input matrix of transform coefficients to provide a transposed intermediate input matrix of transform coefficients, and
a second forward transform module communicatively associated with the first transpose buffer and configured to transform the transposed intermediate input matrix of transform coefficients to provide transformed multimedia data; and
an encoding module communicatively associated with the forward transformation module and configured to compress the transformed multimedia data using a pre-configurable scan order to provide a compressed matrix of transform coefficients.

25. The integrated circuit of claim 21, further comprising:
a display module communicatively associated with the multimedia processing module and configured to facilitate a display of the multimedia data.
